(19) United States
(12) Patent Application Publication
(10) Pub. No.: US 2016/0078688 A1
(43) Pub. Date: Mar. 17, 2016

(54) System and Method to Facilitate On-Demand Parking

(71) Applicant: ZIRX TECHNOLOGIES, INC., San Francisco, CA (US)

(72) Inventors: Sean Behr, San Francisco, CA (US); Shmulik Fishman, San Francisco, CA (US)

(21) Appl. No.: 14/852,488

(22) Filed: Sep. 11, 2015

Related U.S. Application Data
(60) Provisional application No. 62/049,073, filed on Sep. 11, 2014.

(51) Int. Cl. G07B 15/02; G06F 3/0484

(52) U.S. Cl. CPC G07B 15/02; G06F 3/0484

(57) ABSTRACT

System and methods are provided to facilitate on demand parking services. The system includes user interfaces for a customer and agent for coordinating the exchange of a vehicle for storage. The system also includes methods for selecting a desired agent and/or desired parking location from a plurality of available agents and/or parking locations.

### PRIORITY

This application claims priority to U.S. Application No. 62/049,073, filed Sep. 11, 2014, which is incorporated by reference in its entirety into this application.

### BACKGROUND

There are a number of locations in which it is difficult to drive to, park, and leave at a desired time. For example, parking facilities may not be available in close proximity to a desired location, rates may be inconsistent with what a traveler is willing to pay, or it may be difficult to retrieve a vehicle at a given time. Therefore, a traveler may need to know about available parking before arriving at their destination, or otherwise be subject to high rates, difficult terms, or inconvenience and delay of walking. The traveler may have other available options they are unaware of, and a nearby parking facility may be missing opportunities to fill vacant spots by being unaffiliated with an end destination.

### SUMMARY

System and methods are provided herein to assist in on demand parking services. An exemplary system may provide a customer user interface to be displayed on a customer mobile device to permit the customer to enter an address for a vehicle exchange from the customer to an agent for parking. The system may also include an agent user interface for retrieving information about the vehicle exchange and/or indicating an acceptance of the exchange. The system may also include a database for storing information about available agents and available parking facilities. In exemplary embodiments, the system is configured to make prioritized selections of agents and/or parking locations based on one or more considerations.

The system may include an agent selection module configured to select a preferred agent from a plurality of available agents based on a minimum proximity of an associated agent to the address for vehicle exchange, a customer review of the associated agent, a history of the associated agent to the customer, ability of the associated agent, a length of previous duty of the associated agent, an elapse time from a previous job for the associated agent, a total number of jobs performed by the associated agent in a given time period, an estimated response time for the associated agent to arrive at the address for vehicle exchange, a preference of the customer, and combinations thereof.

The system may also include a parking location selection module configured to identify a parking location based on one or more criteria including a permissible duration of parking of an associated parking location, the anticipated duration of parking, parking fees incurred at the associated parking location, available parking spots at the associated parking location, a distance from the address of vehicle exchange to the associated parking location.

### FIGURES

FIG. 1 illustrates an exemplary conventional parking system.

FIG. 2 illustrates an exemplary system in which an agent facilitates the transaction between the person wishing to park and the locations available to park according to embodiments described herein.

FIG. 3 illustrates an exemplary method for implementing embodiments described herein.

FIG. 4 illustrates an exemplary hardware system for supporting the methods described herein.

FIG. 5 illustrates an exemplary block system diagram according to embodiments described herein.

### DETAILED DESCRIPTION

The following detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention. It should be understood that the drawings are diagrammatic and schematic representations of exemplary embodiments of the invention, and are not limiting of the present invention nor are they necessarily drawn to scale.

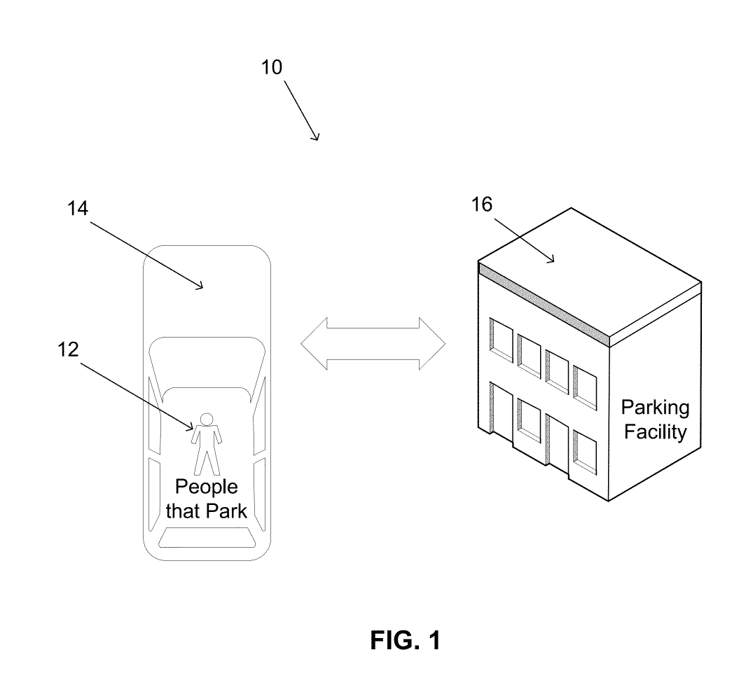

FIG. 1 illustrates an exemplary conventional parking system 10. A person 12 wishes to park a vehicle 14 transacts with a parking facility 16 or a place that permits parking (i.e. lots). The person may pay money to temporarily locate their vehicle while they are visiting an establishment. The person must be aware of the parking location before parking. Therefore, the person must first search for parking before arriving based on a known destination, or simply look in the vicinity of the destination upon arrival. The parking facility may locally advertise through signs and other media to alert potential parkers to their location. Generally, the parking facilities are fixed locations while the vehicle and person wishing to park are in transit to an ultimate destination. The person wishing to park may be limited in their knowledge or awareness of information regarding available parking locations, such as location, pricing, and even their existence. The available lots may also be limited by the proximity to an ultimate destination.

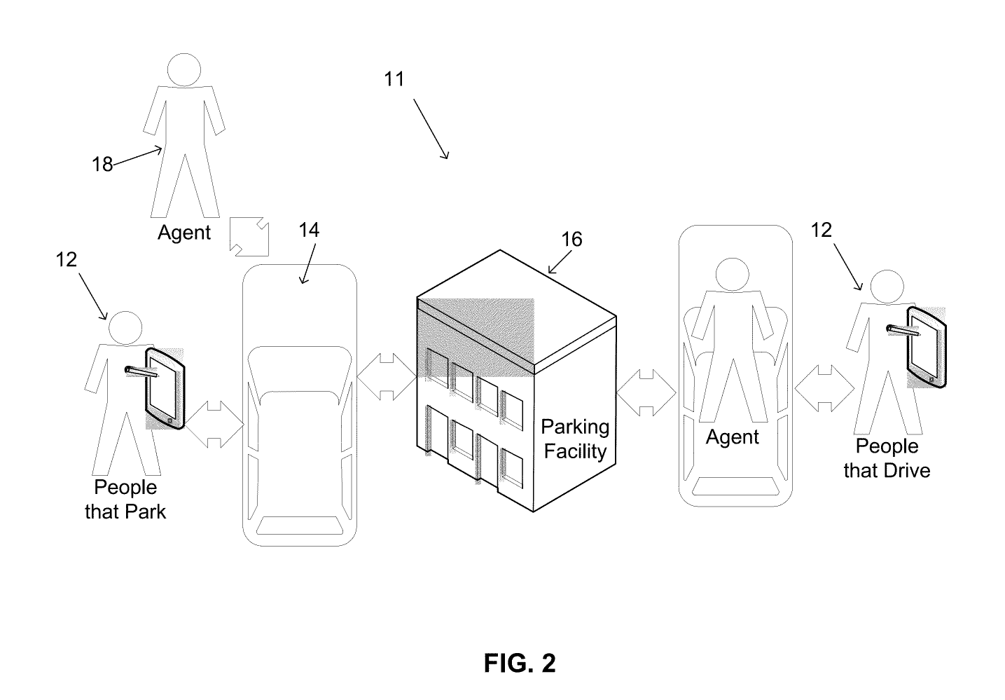

FIG. 2 illustrates an exemplary system 11 in which an agent 18 facilitates the transaction between the person wishing to park and the locations available to park. Embodiments described herein permit the exchange to become efficient, convenient, and mutually beneficial to all involved. The person wishing to park gets personally tailored service in which they can drive to their ultimate destination and leave their car; an agent is employed and receiving payment for their time and service; and the parking facility gets a customer. The transaction is performed with adequate knowledge of available resources, prices, locations, etc. such that the best match may be made between customer (person wishing to park) and service provider (parking facility).

Accordingly, embodiments described herein provide a platform implemented in software, hardware, and a combination thereof, such that the right agent may be matched to the right customer to permit a transaction between the right customer and the right lot at the right time. Embodiments also contemplate the reverse transaction in which the right car is retrieved and returned to the right customer, from the right lot, by the right agent, at the right time. Embodiments described herein provide one or more user interfaces to facilitate the interaction between each party, including, for example, the customer, the agent, the lot, and any combination thereof. Exemplary embodiments may use GPS or other geographic location system to identify customers, agents, and available lots to make a proper association.

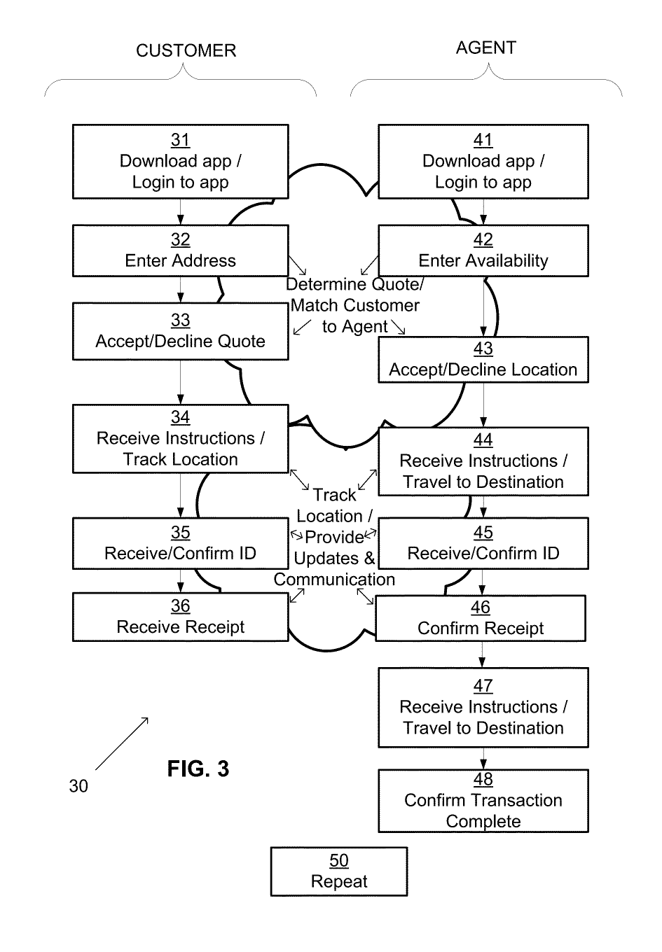

FIG. 3 illustrates an exemplary method 30 for implementing embodiments described herein. The method 30 includes interactions from customer, agent, and/or parking lots/locations.

At step 31, whenever the customer is interested in having a vehicle parked, the customer can launch the customer application and view a customer user interface. At step 32, the system obtains from the customer an address for a vehicle exchange. The customer user interface may present the user with a map for selecting a drop off location, or a text box for entering an address, or combinations thereof. The system may also accept other customer information, such as type of car, expected duration of holding, other desired services, etc. At step 33, the system takes the entered information to determine a quote. The quote is presented to the user for acceptance or rejection.

The system then uses information saved in the database to determine the most appropriate agent and most appropriate parking facility to retrieve the vehicle and store the vehicle for the duration requested. When a customer indicates a desire to use the system and have an agent retrieve their car, the system may match the customer to an agent. Alternatively, the system may provide one or more available agents and/or associated information for selection by a customer.

The system also comprises an application for use by an agent. At step 41, the agent can download an application. The application may be provided individually to an agent once an agent has registered and been cleared for performing the duties of an agent. An agent may therefore be vetted by a program controller. The program controller may interview an agent, run a background check, and may require training before being provided the application for download.

At step 42, the agent may open the application and log into the system. The application may present the agent with an agent user interface. The user interface may present the agent with a login screen to enter a user name and password. At step 42, the agent user interface may permit the agent to indicate whether they are available for performing duties described herein. Once the agent indicates their status, the information is sent to the system to indicate an agent as available or on duty. The system may permit the agent to enter in their availability either as a configured parameter in a profile setting, or dynamically at the time of availability through the agent user interface.

At step 43, the system notifies an agent and provides information to the agent to retrieve the vehicle. In an exemplary embodiment, the agent is provided an address, time, type of car, and customer name, and/or picture to retrieve the vehicle as described herein. The agent may be notified through the agent user interface of a job. The notice may include a time and address for retrieving a vehicle. The agent is then permitted to accept or reject the proposed pickup. If the agent rejects, the next available agent is alerted, repeating steps 41-43 until an agent accepts. If the agent accepts, the agent may then travel to the location to retrieve the vehicle. The user interface identifies the location to the agent, and may provide directions, information on the car received, the customer to retrieve from, and combinations thereof. In an exemplary embodiment, a plurality of agents within a geographic location of the exchange address are provided the exchange address such that each may indicate their acceptance. The system may then either provide further details to the first responder, or to a qualified responder from the set of all responders. Therefore, the system may use one or more methods for identifying a plurality of available agents for a vehicle exchange and selecting one agent to perform the exchange.

At steps 34 and 44, the system provides instructions and updates to the customer and agent, respectively. In an exemplary embodiment, the system may provide a map through the user interface of either the agent and/or customer that indicates the location of the customer and agent on the same map. The location of both the customer and agent may be tracked by the GPS on either of the mobile phones of the agent and customer. The location may be updated in real time or semi-real time so that both or either the agent or customer can confirm the location of the other party to know the time before pickup, confirm identify, etc.

At steps 35 and 45, the customer and agent meet and verify identifications of the other before the vehicle is transferred from the customer to the agent. In an exemplary embodiment, the confirmation may occur through the application run on the mobile phones of the customer and agent. The customer may request a code from the agent when the agent confronts the customer for picking up the vehicle. The customer is provided, through the customer user interface of the application, with a randomly generated code just before the agent retrieves the vehicle. The agent is provided the same code just before or any time before retrieving the vehicle through the agent user interface. The vehicle owner can confirm the agent by comparing codes. Once the customer confirms the code from the agent, the customer can hand over the vehicle to the agent for parking. The user interface of the customer may also provide the customer with a name, phone number, picture, or other information regarding the agent so they can identify the agent and/or communicate with the agent before delivery of the vehicle at the drop off time/place. In an exemplary embodiment, the applications through the mobile device may confirm the identification directly. For example, when the mobile devices are brought within a predetermined distance threshold the mobile devices may acknowledge and verify each other.

At step 46, the agent may confirm receipt of the vehicle through the application, such as through a push button provided with the confirmation code compared with the customer's confirmation code. At step 36, once the transfer is complete, the customer receives an electronic ticket through the application. The ticket can provide receipt information of the transaction. The customer ticket and/or customer user interface may provide the customer a button or other method for indicating the desire to retrieve the vehicle when needed or at a given time.

At step 47, the agent is provided instructions on what to do with the retrieved vehicle. For example, once the transfer is indicated as complete, the agent may be provided through the agent user interface the address of the lot and directions to get to the lot. A map and/or text directions may be provided to the agent and updated depending on the agent location.

Once the agent arrives at the lot, the system may permit the agent through the user interface to confirm arrival. Arrival may also be known to the system by tracking the GPS location of the agent. Once arrival at the lot is confirmed, either by agent action or automatically through GPS tracking, the system provides instructions to the agent on how to store the vehicle. For example, instructions may be provided to take an appropriate ticket from the lot, which parking spot to use, where to locate the keys, lock the vehicle, etc. The agent is then permitted through the user interface to close the transaction.

The agent instructions may include directions or locations to the parking facility. The instructions may also include actions to perform before leaving the vehicle at the parking facility. At step 48, once the instructions are completed, the system permits the agent to confirm the transaction is complete.

Once the transaction is closed, the customer and/or agent may be provided with confirmation of completion. Confirmation of the customer may include a receipt of the transaction and a means, such as a push button user interface, to retrieve their vehicle when desired.

The system may similarly work in reverse when the customer desires the return of their vehicle. The customer through the user interface indicates the return of their vehicle either at a specified time or as soon as possible. An agent is notified and permitted to accept the transaction. The agent is then provided instructions such as the location of the lot, and directions and/or a map to get to the lot. Once at the lot, the agent may be provided instructions through the user interface such as the description of the car, the location of the car, location of keys, etc. Once the car is retrieved, the agent is permitted to indicate the step is complete. The agent is then provided the location and direction to the drop off location. The agent and/or customer are provided details of the other person so that they may find each other. Such information may include name, phone number, picture, etc. The system may provide a map of the customer and agent so that the respective locations may be tracked. The customer may be provided an estimated delivery time that is updated so that the customer may determine when to retrieve the vehicle. Once the agent returns the car, the system may provide an identification code, such as another randomly generated confirmation code, so that the agent and custom may identify each other. Once the transfer is complete, the agent may indicate the transaction is complete, the customer and/or agent may be provided a receipt of the transaction, and the agent's status is updated in the system. After a full transaction, the customer may also be provided an option to rate the experience.

Once the agent accepts a job, their status in the system may be updated as busy so they are not considered for other outstanding requests. Once the agent indicates that the transaction is closed, the agent is identified as available for further transactions.

The system may also coordinate other services for the customer while the vehicle is outside of the possession of the user. For example, the customer may indicate that they wish to have a car wash, oil change, gas fill, or other service rendered to their vehicle. Once the vehicle is in the possession of the agent, the agent may notice one or more items that a customer may appreciate. The agent may suggest items to send to the customer through the customer user interface to confirm whether they wish one or more services to be rendered. For example, if the agent realizes the gas is low, the agent may indicate such status to the system, the system may then ask the customer whether they wish to have their tank filled. The customer may then confirm or reject the request. If confirmed, the service may be added the tasks performed for the vehicle. Therefore, the agent retrieving the vehicle, returning the vehicle, or another agent designated to specifically and only perform the task may be instructed to perform the additional service.

Exemplary embodiments described herein include one or more algorithms for matching or associating the customer to a specific agent and a specific lot. For example, the system may include an agent selection module that may choose a specific agent for a job from a plurality of available agents. The selection module may consider the availability of an agent, a proximity to the pickup location, the previous customer reviews of the agent, the specific history of the agent to customer (i.e. such that a customer with a favorable experience with a specific agent may be matched to the same agent if available and within a certain proximity), the ability of the agent (e.g. if a standard transmission car is retrieved, only agents with the ability to drive a standard is selected), etc. The system may use a dynamic selection of an agent such that one or more parameters is given priority or greater weight depending on the history of the agent and/or customer with the system. Other exemplary features to consider in selecting an agent may include their length on duty, the history of jobs, or lapse between previous jobs, proximity to a given location, response time, etc. Accordingly, an agent may be matched to one or more attributes of the customer and/or vehicle such that the best match may be made. For example, if a customer is new to the system, an agent that is selected may have higher ratings with new customer and/or better skills in communication and/or explaining expectations, close in proximity, available, etc.

In an exemplary embodiment, the system may also learn behaviors of the customer and/or agent. For example, if a customer routinely requests the return of a vehicle at a certain duration and/or time, the system may request an agent be available when necessary so that the response time may be improved. The system may also track, for example, that a person drops off a vehicle and retrieves the vehicle at different locations. Therefore, the lot chosen may be based on an anticipated pick up location instead of the drop off location, such that the response time may be improved.

The system may similarly match a lot to a transaction. The system may therefore include a parking location selection module. The lot may be selected based on whether it is open or closed at the given drop off and pick up times, the proximity to the pick up or drop off locations, the duration of storage, the cost of storage, available services provided or in proximity to the lot, travel time to or from the lot, available spaces, and combinations thereof.

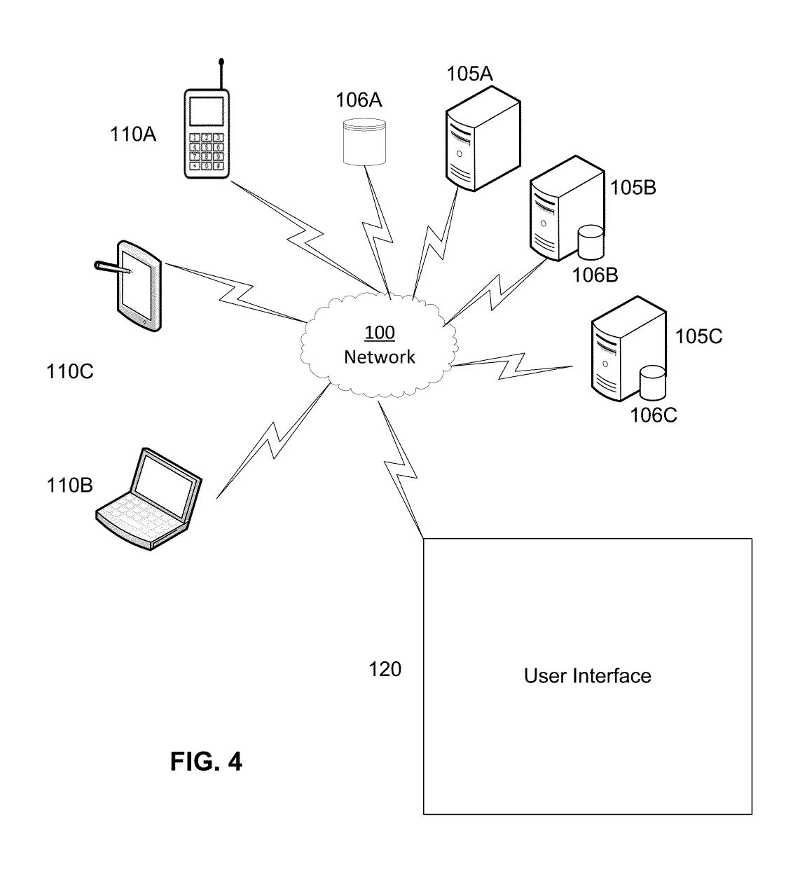

FIG. 4 illustrates an exemplary hardware system for supporting the methods described herein. In an exemplary embodiment, the system comprises an application that is configured to present a user with a user interface 120 to interact with the system. The application can be downloaded from an application store and stored on a mobile device. The user interface 120 may also be one served from a remote server to the mobile device screen. For example, a web browser may be used to render the user interface through a website application. The mobile device, such as smart phone 110A, laptop 110B, or mobile computer 110C (e.g. tablet), includes memory and processor for storing and executing software for performing functions described herein. The application presents a user interface to a user. The user interface is configured to permit a user to register with the system. The user can enter in personal information such as name, email, phone, credit card, etc. The system may then communicate the entered information to a database 106A-106C stored remotely such as on a server 105A-105C. The application may communicate over a network 100, such as the internet to a database stored on a remote server. One or more databases and servers may be used to facilitate the functions described herein.

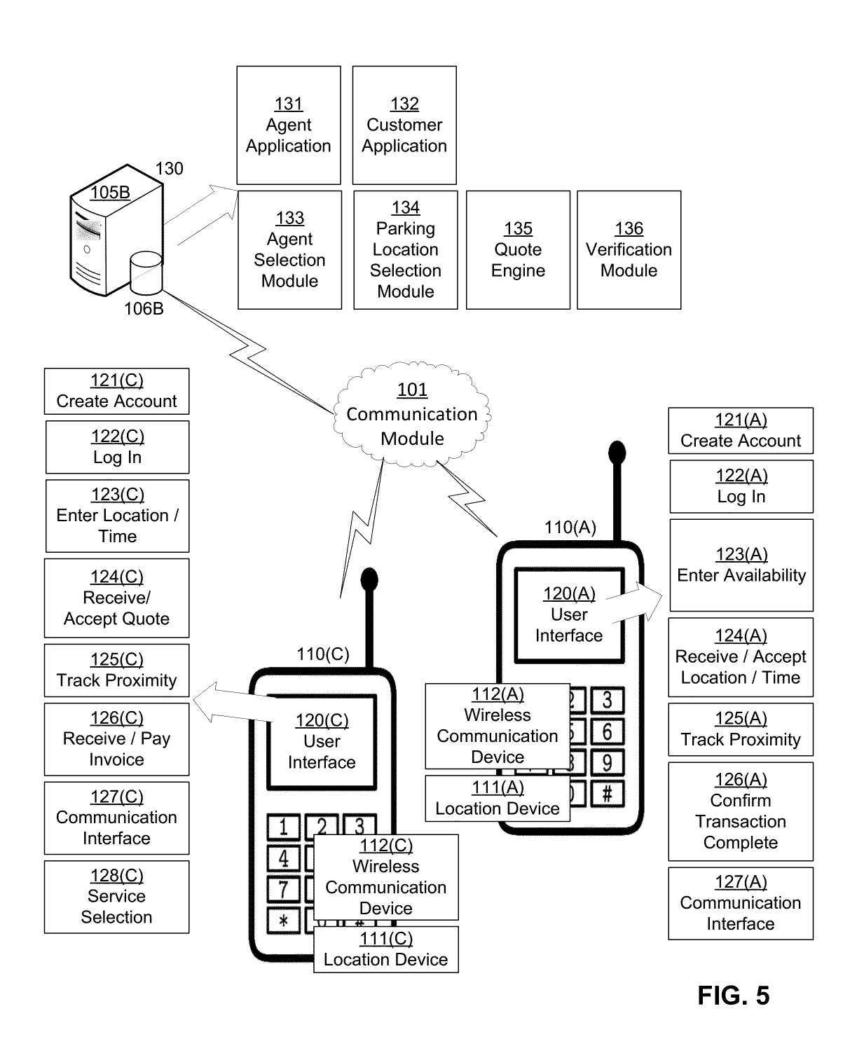

FIG. 5 illustrates an exemplary block system diagram. In an exemplary embodiment, the system comprises a communication module 101 and remote computer system 130 configured to communicate with an agent mobile device 110(A) and a customer mobile device 110(C).

In an exemplary embodiment the remote computer system 130 comprises a server 105B and database 106B for storing information entered by the customer and agent. The information is retrieved through the user interfaces of the agent and customer from the mobile devices and sent to the remote computer system over the communication module. The communication module may be configured to take information from the customer through the customer user interface and supply information to the agent through the agent user interface. The communication module 101 may include wired and/or wireless communication from and between the mobile devices 110(C), 110(A) through the application resident on the mobile devices and the remote computer system 130. An exemplary communication module 101 may comprise or may be configured to transmit information using the mobile communication or cellular network, the internet, private or public networks, and combinations thereof.

The remote computer system 130 may include hardware for storing and executing non-transitory computer readable medium to perform the functions described herein. The remote computer system 130 may include the agent application 131 and customer application 132 available for download to the customer mobile device 110(C) and the agent mobile device 110(A). Once downloaded, a copy may be stored on the mobile device, such that the mobile device comprises hardware for storing and executing the applications. Once downloaded, the customer mobile device may comprise a resident customer application stored and executed by the customer mobile device 110(C). Once downloaded, the agent mobile device may comprise a resident agent application stored and executed by the agent mobile device 110(A). When the resident agent or customer applications are executed from the respective mobile devices, the respective devices will display a user interface (agent user interface 120(A) and customer user interface 120(C)). Each of the mobile devices may also include a wireless communication device 112(C)/112(A) such that the system may receive information from the respective user interfaces and communicate the information from or between the mobile devices and the remote computer system. Each of the mobile devices may also include a location device 111(C)/111(A), such as GPS, for providing a current position of the mobile device. The resident application is configured to communicate with the device's location device in order to obtain a present position of the mobile device. The system, such as through the communication module, may be configured to retrieve a periodically updated present location of the agent and/or customer and provide information associated with the present location to the other. The update may be continuous such that real-time location is provided, or may be periodic on a predetermined interval.

The resident consumer application is configure, when executed by the consumer mobile device, to display a consumer user interface 120(C) to the user. The consumer user interface permits the customer to enter and receive information from the system or agent. One or more interfaces may be made available to the customer.

In an exemplary embodiment, the customer may be presented with a user interface for creating an account 121(C). The user may be permitted in enter personal information such as name, home or work address, payment information, age, gender; vehicle information such as make, model, year, and transmission type; preferences; and account information such as password and user name. After an account is created, the user interface 122(C) may permit the user to log into the system. In an exemplary embodiment, the log in may merely be launching the application or may include entering account information, such as user name and password.

The resident customer application is downloadable to and executed from a customer mobile device configured to display the customer user interface to the customer on the customer mobile device. Once the resident customer application is launched, the customer user interface may include a user interface configured to permit a customer to enter a location and/or time for a vehicle exchange. The user interface may include text boxes, drop down selection, map interface, buttons, etc. for entering, choosing, or selecting a location manually or automatically from the present location as determined by the location device 111(C) of the mobile device. In an exemplary embodiment, the resident customer application is configured to retrieve customer location from the customer mobile device.

The user interface may then permit the user to display and accept a quote 124(C) generated by the entered and/or stored information as communicated to or from the remote computer system. Therefore, the customer user interface may be configured to display an estimated value of the vehicle exchange and permit the customer to accept the estimated charge before the agent receives information about the vehicle exchange.

After the transaction is confirmed, the user interface may include a display for tracking the proximity of the agent 125(C). The user interface 125(C) may include a map interface with indicators of the agent and customer present locations. In an exemplary embodiment, the customer user interface is configured to display a map of the address and indicate the present location of the agent on the map to the customer. The user interface 125(C) may also include text or other indicators of the estimated time of and/or to arrival by the agent, and/or an approximate distance (either linear or navigable) between the agent and customer. Therefore, the customer user interface may be configured to display an estimated time of arrival or estimated time to arrival of the agent at the address. Once the exchange occurs, the user interface may include a display for presenting and/or paying the associated invoice of the transaction. Another exemplary consumer user interface may include a communication interface 127(C) such that the consumer may communicate with or provide information to the agent. Another exemplary consumer user interface may include a service selection 128(C) that permits the consumer to select additional services available during the parking of the car, including, for example, wash, gas, etc.

In an exemplary embodiment, the agent may be presented with a user interface for creating an account 121(A). The user may be permitted to enter personal information such as name, home or work address, age, gender; driving limitations; preferences; and account information such as password and user name. After an account is created, the user interface 122(A) may permit the user to log into the system. In an exemplary embodiment, the log in may merely be launching the application or may include entering account information, such as user name and password.

The resident agent application is downloadable to and executed from an agent mobile device configured to display the agent user interface to the agent on the agent mobile device. Once the resident agent application is launched, the agent user interface may include a user interface configured to permit an agent to receive information about the vehicle exchange and indicate an acceptance of the vehicle exchange. The user interface may also permit an agent to enter an availability 123(A) for the vehicle exchange according to embodiments described herein. The availability may be set at pre-set times, such as through a user preferences set up, or may be set up dynamically in which a known or present window of availability becomes known to an agent. Once the agent presently becomes available, the resident agent application may retrieve a present agent location and communicate through the communication module 101 to the remote computer to save a present location and indication of availability of the agent. Therefore, in an exemplary embodiment, the resident agent application is configured to retrieve agent location from the agent mobile device.

Once the system has set the agent's present status to available, and a request has been created by a customer by entering in a location/time through the customer user interface, the agent user interface may permit the agent to view information about the vehicle exchange, and/or accept or decline the exchange 124(A). Once the agent has accepted the vehicle exchange, the user interface may include a display for tracking the proximity of the agent or the customer 125(A). The user interface 125(A) may include a map interface with indicators of the agent and customer present locations. In an exemplary embodiment, the agent user interface is configured to display a map of the address and indicate the present location of the agent on the map. The user interface 125(A) may also include text or other indicators of the estimated time of and/or to arrival by the agent, and/or an approximate distance (either linear or navigable) between the agent and customer. Therefore, the agent user interface may be configured to display an estimated time of arrival or estimated time to arrival of the agent at the address. The agent user interface may also be configured to provide instructions to the agent before and/or after the vehicle exchange including providing directions for pick up/drop off, identifying the parking location, providing details on how and where to leave the vehicle, providing additional services to perform on or to the vehicle and how or where to perform those services. The agent user interface may also permit the agent to periodically check in, such as after one or more specific tasks or locations, confirming the transaction has occurred 126(A) before or while receiving instructions. Another exemplary agent user interface may include a communication interface 127(A) such that the agent may communicate with or provide information to the customer. The communication interfaces 127(C) and 127(A) may include text type windows through the application, such that text or chat messages may be sent between the customer and agent. Other communication templates may be used, such as if an agent identifies additional services the user may be interested in. The system may facilitate a template of available services or requesting confirmation of one or more services as entered by the agent.

The system may further include a selection module 133 configured to identify a set of available agents and select a preferred agent from the set of available agents. In an exemplary embodiment, the system may retrieve or consider information stored in the database 106B to identify the set of available agents within a predetermined proximity to the address for vehicle exchange. The proximity may be determined by geographic location, such as within a given radius of or length of travel to the address for the vehicle exchange, or by a time proximity to arrive at the address for the vehicle exchange. Once an available set of candidates is identified, a preferred agent selected to receive information about the vehicle exchange. The preferred agent may be selected based on one, two, three, or more factors including, for example, on a minimum proximity of an associated agent to the address for vehicle exchange, a customer review of the associated agent, a history of the associated agent to the customer, ability of the associated agent, a length of previous duty of the associated agent, an elapse time from a previous job for the associated agent, a total number of jobs performed by the associated agent in a given time period, an estimated response time for the associated agent to arrive at the address for vehicle exchange, a preference of the customer, or other considerations as described herein, and any combination thereof.

The system may also include a parking selection module 134 configured to select the parking location from a plurality of parking locations. Similar to the agent selection module 133, the parking location selection module 134 may first identify a plurality of parking location proximally located to the vehicle exchange address (either for actual or anticipated drop off or delivery). The system may then determine an optimal parking location based on one or more criteria including a permissible duration of parking of an associated parking location, the anticipated duration of parking, parking fees incurred at the associated parking location, available parking spots at the associated parking location, a distance from the address of vehicle exchange to the associated parking location.

The system may also include a quote engine 135 configured to determine an estimated value to charge the customer for the vehicle exchange. The estimated value may be based on a distance from the address of vehicle exchange to a parking location, an anticipated duration of parking, parking fees from the parking location, and combinations thereof.

The system may also include a verification module 136 configured to confirm the identity of the customer and agent such that the exchange can be made with the assurance the exchange is occurring between the correct people. In an exemplary embodiment, the verification module is configured to supply a unique identifier to the customer user interface and the agent user interface. The customer and/or agent can request the unique identifier or read the identifier from the other's mobile device. The verification module 136 may also provide an image, name, description, or other information of the agent or customer to the other of the customer or agent.

The agent selection module 133, parking location selection module 134, quote engine 135, verification module 136 and any other functional module and algorithms may be non-transitory machine readable executable code stored at the remote computer system 105B and when executed, configured to retrieve information from the database 106B and/or from either or both of the customer and agent resident applications (such as user entered information or system information including location information) to perform the respective functions. These functional modules may also be configured to interface with the communication module 101 such that information generated by the modules may be sent to the customer or agent resident application. The modules are described as having certain functions that may make select determinations on one or more attributes. These functions and attributes are not limited to those disclosed, but instead contain any combination described herein or otherwise available.

The system uses information saved in the database to determine the most appropriate agent and most appropriate parking facility to retrieve the vehicle and store the vehicle for the duration requested. The database may include information entered by the customer, agent, parking location administrator, and/or system administrator. The database may therefore store information about the customer, such as name, gender, image, payment information, home or work address, present location, and/or vehicle information, such as make, model, transmission type, size, present location, storage details. The system may also store information about the agent such as name, present location, image, availability. The system may also store information about parking locations, such as facility address, facility type (gated, enclosed, roofed, guarded, long term, short term, . . . ), cost. The system may include a user interface for entering, deleting, or modifying the information stored in the database. The user interface may be run on a computer, for example.

In an exemplary embodiment, a system administrator may be used to facilitate parking locations. The system administrator may therefore have prearranged or reserved locations, pricing, etc. from one or more available locations within a geographic area. The system administrator may therefore identify a set number of available parking locations available for use by the system and reserved by the system administrator based on the expected use in a given geographic area. Exemplary embodiments permit a system administrator to set preferences, receive alerts, or retrieve or analyze information of the system. In an exemplary embodiment, if a system administrator manages the parking locations, such that a prearrange number of locations are reserved for use by system customers, the system may be configured to alert the administrator when a geographic area is low on available parking locations, or when the consistent use of parking in a given area is high such that additional agents and/or parking locations is desirable. Conversely, the system may alert a system administrator when a number of parking locations are not consistently used, such that inventory of available spaces may be reduced.

In an exemplary embodiment, administrators of parking facilities may provide parking information for their respective locations to the system through a parking user interface. The parking user interface may be a mobile application or may be a web based user interface accessible through a web browser. The parking administrators may provide location information, prices, availability, lot characteristics, through the parking user interface. The parking user interface may be used in conjunction with a system administrator to manage and confirm available parking locations of one or more parking providers.

Some portions of the detailed descriptions above are presented in terms of algorithms or modules or engines and symbolic representations of operations on data bits within a computer memory. These algorithmic descriptions and representations are the means used by those skilled in the data processing arts to most effectively convey the substance of their work to others skilled in the art. An algorithm, module, or engine is here, and generally, conceived to be a self-consistent sequence or alternative set of sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. The exemplary embodiments identify these algorithms, modules, and engines as separate logic units stored at physical locations and executed by specific devices. However, these algorithms may be integrated, combined, subdivided, distributed, or otherwise reconfigured to be stored and/or executed across one or more servers, remote computers, communication networks, mobile devices, etc. The exemplary combination of functions is also illustrative only, and any combination of features may be included or combined to achieve the desired level of functionality.

Exemplary embodiments are described herein in terms of parking services and transportation. However, it should be understood that embodiments of this invention are not so limited, but are additionally applicable to other services or industries in which different entities require an intermediary to facilitate an exchange. For example, other goods may include personal items, clothes, luggage, etc. Furthermore, although embodiments of the invention may be described and illustrated herein in terms of a website application, it should be understood that embodiments of the invention are also applicable to other interfaces, such as mobile applications, portals, dedicated electronic devices, and configurations in which a consumer may place an order through an interface communicating through a network to a host system.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims.

What is claimed is:

1. A system for facilitating on demand parking services, comprising:
a customer user interface configured to permit a customer to enter an address for vehicle exchange;
an agent user interface configured to permit an agent to receive information about the vehicle exchange and indicate an acceptance of the vehicle exchange; and
a communication module configured to take information retrieved from the customer through the customer user interface and supply information to the agent through the agent user interface.

2. The system of claim 1, further comprising a selection module configured to identify a set of available agents within a predetermined proximity to the address for vehicle exchange and select a preferred agent to receive information about the vehicle exchange.

3. The system of claim 2, wherein the selection is made on a minimum proximity of an associated agent to the address for vehicle exchange, a customer review of the associated agent, a history of the associated agent to the customer, ability of the associated agent, a length of previous duty of the associated agent, an elapse time from a previous job for the associated agent, a total number of jobs performed by the associated agent in a given time period, an estimated response time for the associated agent to arrive at the address for vehicle exchange, a preference of the customer, and combinations thereof.

4. The system of claim 2, wherein the selection is made on a combination of preferred attributes including three or more of a minimum proximity of an associated agent to the address for vehicle exchange, a customer review of the associated agent, a history of the associated agent to the customer, ability of the associated agent, a length of previous duty of the associated agent, a total number of jobs performed by the associated agent in a given time period, an elapse time from a previous job for the associated agent, an estimated response time for the associated agent to arrive at the address for vehicle exchange, and a preference of the customer.

5. The system of claim 3, further comprising a quote engine configured to determine an estimated value to charge the customer for the vehicle exchange based on a distance from the address of vehicle exchange to a parking location, an anticipated duration of parking, parking fees from the parking location, and combinations thereof.

6. The system of claim 5, wherein the customer user interface is configured to display the estimated value and permit the customer to accept the estimated charge before the agent receives information about the vehicle exchange.

7. The system of claim 6, wherein the communication module is configured to retrieve a periodically updated present location of the agent and provide information associated with the present location to the customer.

8. The system of claim 7, wherein the customer user interface is configured to display a map of the address and indicate the present location of the agent on the map to the customer.

9. The system of claim 7, wherein the customer user interface is configured to display an estimated time of arrival or estimated time to arrival of the agent at the address.

10. The system of claim 7, further comprising:
a resident customer application downloadable to and executed from a customer mobile device configured to display the customer user interface to the customer on the customer mobile device; and
an resident agent application downloadable to and executed from an agent mobile device configured to display the agent user interface to the agent on the agent mobile device.

11. The system of claim 10, wherein the communication module comprises a wireless network that is configured to communicate between the resident customer application, the resident agent application, and a remote system comprising a database of information.

12. The system of claim 10, wherein the resident customer application is configured to retrieve customer location from the customer mobile device, and the resident agent application is configured to retrieve agent location from the agent mobile device.

13. The system of claim 12, further comprising a verification module configured to supply a unique identifier to the customer user interface and the agent user interface.

14. The system of claim 10, wherein the agent user interface is configured to provide instructions to the agent after the vehicle exchange including identifying the parking location.

15. The system of claim 14, further comprising a parking selection module configured to select the parking location from a plurality of proximately located parking locations.

16. The system of claim 15, wherein the parking selection module selects the parking location based on one or more criteria including a permissible duration of parking of an associated parking location, the anticipated duration of parking, parking fees incurred at the associated parking location, available parking spots at the associated parking location, a distance from the address of vehicle exchange to the associated parking location.

17. The system of claim 16, wherein the customer user interface is configured to receive a time associated with vehicle exchange.

18. The system of claim 17, wherein the vehicle exchange comprises a vehicle drop off or a vehicle pick up by the customer from the agent.

19. A method for on demand parking services, comprising:
receiving an address for vehicle exchange from a customer through a customer user interface displayed on a customer mobile device;
receiving an indication of acceptance of the vehicle exchange by an agent through an agent user interface after the agent received information about the vehicle exchange through the agent user interface displayed on an agent mobile device; and
communicating information retrieved from the customer through the customer user interface to the agent through the agent user interface.

20. The method of claim 20, further comprising:
selecting an a preferred agent from a plurality of available agents based on a minimum proximity of an associated agent to the address for vehicle exchange, a customer review of the associated agent, a history of the associated agent to the customer, ability of the associated agent, a length of previous duty of the associated agent, an elapse time from a previous job for the associated agent, a total number of jobs performed by the associated agent in a given time period, an estimated response time for the associated agent to arrive at the address for vehicle exchange, a preference of the customer, and combinations thereof; and
selecting a parking location based on one or more criteria including a permissible duration of parking of an associated parking location, the anticipated duration of parking, parking fees incurred at the associated parking location, available parking spots at the associated parking location, a distance from the address of vehicle exchange to the associated parking location.
